(19) United States
(12) Patent Application Publication
(10) Pub. No.: US 2003/0052308 A1
(43) Pub. Date: Mar. 20, 2003

(54) Slurry composition of chemical mechanical polishing

(76) Inventors: Shao-Chung Hu, Taipei City (TW); Teng-Chun Tsai, Hsin-Chu City (TW); Chia-Lin Hsu, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 09/682,548

(22) Filed: Sep. 19, 2001

(51) Int. Cl. C09K 3/14; C09C 1/68; B24D 3/02; C23F 11/00; C09K 3/00

(52) U.S. Cl. 252/387; 51/308

(57) ABSTRACT

A slurry composition for chemical mechanical polishing (CMP) is provided. The slurry has a component of abrasives, such as alumina, silica, ceria, etc, an aqueous ozone with determined concentration, and an additive. A pH value of the slurry composition is between 1 and 10.

### BACKGROUND OF INVENTION

1. Field of the Invention

The present invention relates to a slurry composition of chemical mechanical polishing (CMP), and more particularly, to a slurry composition with ozone functioning as an oxidant.

2. Description of the Prior Art

With integrated circuit development trends moving toward smaller and more densely packed devices, a multilevel metallization process that uses a plurality of metal interconnection layers and low dielectric constant materials to connect semiconductor devices and complete a stacked circuit structure is widely applied in VLSI/ULSI processes. However, the metal wires and semiconductor devices form severe topography on the surface of the integrated circuits, thereby increasing the difficulty of performing deposition or transferring patterns. Therefore, protruding places and an uneven surface profile of the deposition layer need to be removed by a planarization process.

Chemical-mechanical polishing (CMP) is the most widely applied planarization technique. Chemical-mechanical polishing is similar to mechanical polishing in its use of a “blade”principle,of which adequate chemical additives of slurry react with the surface of the semiconductor wafer to polish the unevensurface profile of the wafer to achieve planarization. If the various process parameters are properly controlled, the CMP process can provide more than a 94% flatness of the polished surface. Therefore,in sub-micron semiconductor process, the semiconductor industry has adopted this more effective CMP process for global planarization, sincehigher qualityis requiredbya resolution limitation of a photolithography process.

The CMP process was applied to metal layer planarization in the late 1980's. The metal materials include aluminum alloy, titanium (Ti), titanium nitride (TiN), tungsten (W), tantalum (Ta), and copper (Cu). Polishing these metal materials requires a slurry with different properties and relates to a complex chemical reaction. The slurry for polishing a silicon oxide layer comprises a base solution such as potassium hydroxide (KOH) and ammonium hydroxide (NH₄OH) mixed with colloidal silica or dispersed alumina. These highly abrasive particles of the slurry are used to polish the surface of the semiconductor wafer during the CMP process. But, when the polished materials are metal materials, the slurry composition also comprises an oxidant and organic agents.

The oxidant is one of the most important agents of the polishing mechanism. When the oxidant performs a reductive reaction, the metal layer on the surface of the semiconductor wafer forms a metal oxide layer by increasing an oxidative state. Because the hardness of the metal oxide layer is less than that of the metal layer, the metal oxide layer is easily and rapidly removed by mechanical polishing of CMP polishing particles and a polishing pad. In addition, the metal oxide layer covers the metal layer to form a passivation layer that prevents internal metal oxidation. The place protruding out of the surface of the semiconductor wafer is polished by mechanical polishing of CMP to remove the metal oxide on the surface of the metal. By the reaction between the metal and slurry, metal oxide is continually formed on the surface and polished again until the protruding place is totally removed. In a concave place, metal oxide still forms on the surface and protects inside metal from wet etching by the slurry. Therefore, the protruding surface becomes planar and the concave place is not damaged by this mechanism, so that the surface planarization of the semiconductor wafer is increased.

Taking copper CMP as an example, copper can be oxidized to cuprous oxide in a water solution environment. The half oxidative reaction is as follows:

2Cu+H O⇄Cu O+2H⁺+2e⁻

And the erosion and dissolve reactions during polishing are as follows:

2Cu²⁺+2e⁻⇄Cu

or 2Cu²⁺2e⁻+H O⇄Cu O+2H⁺

In electrochemistry, redox (reductive-oxidative) reactions are electron transfer between chemical species of the reaction. A species losing electrons is an oxidative reaction, a species gaining electrons is a reductive reaction, and the two reactions must occur simultaneously. Therefore, an oxidant must exist to react with copper, so that copper can be oxidized. Copper can react with oxygen dissolved in the water to perform the redox reaction, wherein the half reductive reaction of oxygen is as follows:

2O+H O+2e⁻⇄4OH⁻

Not only due to oxygen, metal is easily oxidized in the acid solution because the hydrogen ion (H⁺) in the solution is used as an oxidant to oxidize metal. Finally, the hydrogen ion forms hydrogen by a reductive reaction, and the reaction is as follows:

2H⁺+2e⁻⇄H

Whether the redox reaction is self-directed or not is determined by the magnitude, and the positive or negative orientation, of the potential of redox reaction. If the potential of the half reductive reaction of one species is positive, the free energy of the reaction is less than zero. Therefore, the reductive reaction is self-directed and the species is a strong oxidant. On the other hand, if the potential of the reductive reaction is negative, the reductive reaction is not easily performed.

In addition, metal under different oxidizing environment performs different reaction to form different stable species. In order to anticipate the polishing efficiency, the Pourbaix diagrams are used to anticipate the oxidative reaction and thermodynamic balanced product of the metal under a pure water environment. Please refer to FIG. 1. FIG. 1 is the Pourbaix diagram of a copper-pure water system. It shows the erosion behavior of the copper in the water solution. As shown in FIG. 1, copper is not affected by the pH value when no oxidant exists, so that copper still maintains the original copper metal state without performing the oxidative reaction. And, under an acidic (pH<5) and high oxidizing ability environment, copper metal is intended to be oxidized to a soluble cupric ion (Cu²⁺), that is performing an erosion reaction without forming cupper oxide on the surface. The same erosion reaction can be performed under a highly basic (pH>13) and oxidant-containing environment, where copper metal is intended to be oxidized and form a water-soluble oxide (CuO₂²⁻). Only in the weakly basic water solution (7<pH<13) with oxidant existence can copper metal be oxidized into cuprous oxide (Cu₂O) or cupric oxide (CuO) formed on the surface as a passivation layer. However, FIG. 1 is only copper species distribution in the pure water. Each different system has a different distribution, and FIG. 1 shows the influence of pH value and oxidant existence on the species distribution.

Thereby, for metal chemical mechanical polishing, the formation rate and properties of metal oxide are key factors influencing the polishing performance in areas such as uniformity, planarization, dishing and erosion effects. The properties and concentration of oxidant in the slurry determine the behavior of metal oxidation.

Therefore, slurries of the prior art are divided into two groups:

1. metallic oxidants:

This kind of oxidant includes ferric nitrate (Fe(NO₃)₃), potassium iodate (KIO₃), ferricyanide (Fe(CN)₆³⁻), etc.. Because of having better stability and being uneasily degradable, ferricyanide is widely used as a metallic oxidant. It can be reduced to ferrocyanide (Fe(CN)⁴⁻), and the reductive reaction is as follows:

Fe(CN)³⁻+e⁻⇄Fe(CN)⁴⁻

U.S. Pat. No. 5,340,370 discloses a polishing slurry for tungsten, including 0.1M potassium ferricyanide (K₃Fe(CN)₆), 5% silica and potassium acetate (KCH₃COO). Acetic acid is used to adjust the pH to under 3.5. However, these kinds of oxidants easily cause metal ion contamination, such as a presence of Fe³⁺ or K³⁰ , on the surface of the semiconductor wafer. Therefore, for metal CMP, current slurries are moving toward using nonmetallic oxidants.

2. nonmetallic oxidant:

The most widely used kind of oxidant is hydrogen peroxide (H₂O₂). The half reductive reaction is as follows:

H O+2H⁺+2e⁻⇄2H O

In U.S. Pat. No. 5,244,534 related to a slurry composition comprising Alumina, hydrogen peroxide, aluminum hydroxide (or potassium hydroxide) is used to remove tungsten metal. U.S. Pat. No. 5,209,816 also discloses a slurry comprising perchloric acid, hydrogen peroxide, solid abrasive and solution medium to polish aluminum metal. However, too much hydrogen peroxide easily contaminates the semiconductor wafer and a pH value of the hydrogen peroxide solution easily varies during the reductive reaction, thereby affecting the whole CMP process.

### SUMMARY OF THE INVENTION

It is therefore a primary objective of the present invention to provide a slurry composition of chemical mechanical polishing to solve the above-mentioned problems.

In accordance with the claim invention, a slurry composition of chemical mechanical polishing (CMP) comprises a component of abrasives, such as alumina, silica, ceria, etc, an aqueous ozone with determined concentration, and an additive. The pH value of the slurry composition is between 1 and 10.

In contrast to an oxidant component of a CMP slurry used in the prior art, the present invention uses ozone as an oxidant of the CMP slurry to improve an oxidative ability, thereby avoiding drawbacks of contamination in the semiconductor wafer and pH value variation of the slurry according to the prior art.

These and other objectives of the present invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 is a Pourbaix diagram of a copper-pure water system.

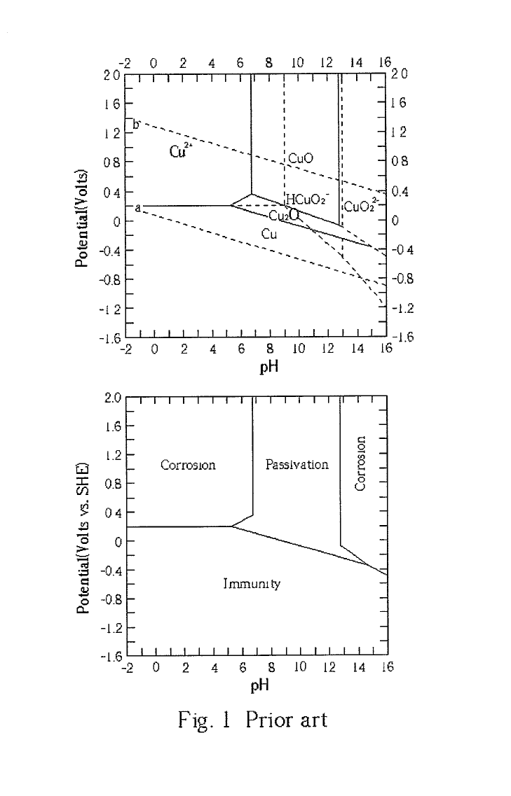

FIG. 2 is a table of reductive reaction potential of each chemical species.

FIG. 3 is two embodiments of slurries according to the present invention.

### DETAILED DESCRIPTION

The slurry composition of the present invention includes alumina (an abrasive), an additive having some chemical components, and ozone (an oxidant component).

The abrasive of the present invention is typically a metal oxide, such as alumina, titania, zirconia, germania, silica, ceria or a mixture of the above. Alumina is used in the preferred embodiment of the present invention, and the weight percent is between 1.5 to 6%.

The additive of the present invention includes a corrosion inhibitor to protect the metal oxide and inhibit the erosion reaction. Nitrogen-containing cyclic compounds are usually used for the corrosion inhibitor, such as imidazole, benzotriazole, benzimidazole, benzothiazole, urea, or a mixture of these compounds. In the preferred embodiment, the corrosion inhibitor is benzotriazole (BTA) with a weight percent between 0.01 to 2%.

The additive of the present invention can further include a complexing agent to disturb the passivation layer, so that the metal oxide is easily removed from the surface of the wafer. Useful complexing agents include citric acid, lactic acid, malonic acid, tartaric acid, succinic acid, acetic acid, oxalic acid, amino acid, amino sulfuric acid, phosphoric acid, phophonic acid, etc. The preferred embodiment uses tartaric acid with a weight percent of 0.2-5%. Wherein, the complexing agent being almost unnecessary in the present invention, other embodiments without a complexing agent are also applicable.

Moreover, due to an addition of various chemical agents, the abrasive of the CMP slurry may destablize to have flocculation, decomposition and settling situations. Therefore, the additive may further include surfactant, stabilizer, or dispersing agent to stabilize the CMP slurry. Taking surfactant as an example, the embodiment would use dodecyl sulfate, sodium salt, sodium lauryl sulfate, dodecyl sulfate ammonium salt, or a mixture of the above. The amount of the surfactant added must be enough to stablize the CMP slurry and depends on characteristics of the sufactant and the abrasive surface. The addition of the surfactant can decrease inequality and defects of the surface of the semiconductor, but too much surfactant will cause flocculation and foaming in the slurry. Therefore, the weight percent of the surfactant is between 0.001 to 2%. The surfactant is almost unnecessary in the present invention, such that other embodiments without surfactant are also applicable.

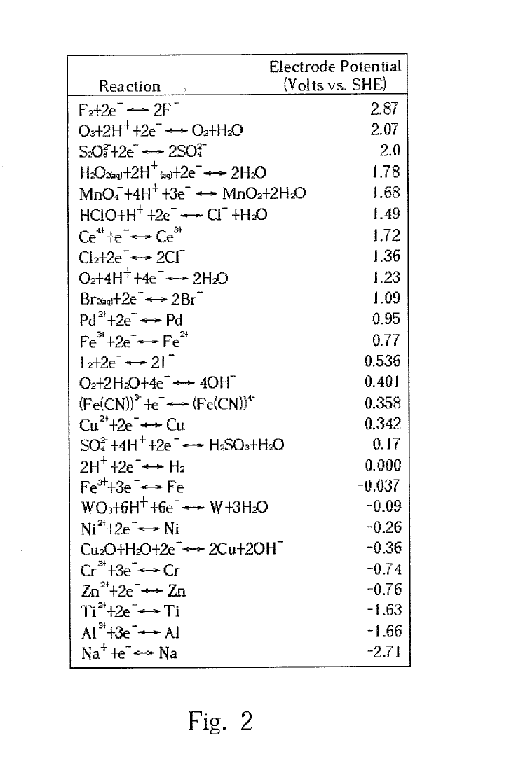

The oxidant of the present invention is a nonmetallic oxidant, ozone. Please refer to FIG. 2. FIG. 2 is a table of reductive reaction potential of each chemical species. As shown in FIG. 2, the oxidative potential of ozone is 1.78V, its oxidative ability is only less than fluorine, but higher than other commonly used oxidants, such as hydrogen peroxide and ferricyanide. Therefore, dissolving ozone into solution, it is easy to gain better oxidative effects. The half reductive reaction of ozone is as follows:

O+2H⁺+2e⁻⇄O+H O

Because the products of the half reductive reaction are hydrogen and oxygen, there are no contamination problems of metal ions and no pH value variation such as occurs when using hydrogen peroxide. In addition, an ozone satisfaction amount in the solution follows Henry's law (m=kP), that is, ozone pressure is proportional to ozone solubility. Therefore, the solubility of ozone is well controlled by adjusting process parameters.

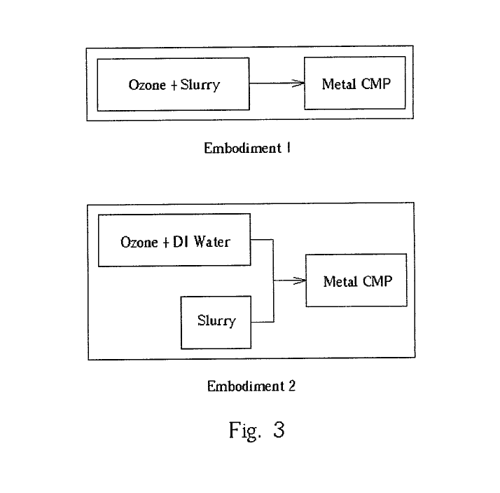

Therefore, the present invention uses ozone as an oxidant of metal CMP slurry. Please refer to FIG. 3 of two embodiments of slurries according to the present invention. As shown in FIG. 3, the two embodiments using ozone as an oxidant are as follows:

1. Directly inject dissolved ozone with a concentration between 0.1-200 parts per million (PPM) into a slurry comprising an abrasive, water, and an additive for CMP process.

2. Inject dissolved ozone to deionized water to form an ozone solution, and mix a slurry comprising abrasive, water, and an additive with the ozone solution for CMP process.

Because the pH value of the CMP slurry has an important influence on the chemical species to which metals oxidize, the pH value of the present invention is between 1 and 10 to control the CMP process. The pH value is adjusted by acid, base, or amine, but limited to chemicals without metal ions, such as ammonium hydroxide, amine, nitric acid, phosphoric acid, sulfuric acid and organic acid, to prevent metal ion contamination.

Above all, the present invention uses an ozone-containing slurry for metal CMP. Because ozone is a strong nonmetallic oxidant, the ozone-containing solution easily gains a better oxidative effect. In addition, ozone easily reacts with organic chemicals, so that some carbon particles in the slurry are easily removed by ozone. Therefore, the present invention uses the ozone as an oxidant of the slurry to heighten the CMP performance and slurry stability and also avoid some drawbacks of metal ion contamination and pH value variation related to prior art.

In contrast to the oxidant component of the CMP slurry according to the prior art, the present invention uses ozone as an oxidant of the CMP slurry to have a better oxidative ability, thereby avoiding the drawbacks of contamination in semiconductor wafer and pH value variation of the slurry according to prior art.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A slurry composition of chemical mechanical polishing (CMP), the slurry composition comprising:
a component of alumina;
an aqueous ozone with predetermined concentration; and
an additive;
wherein a pH value of the slurry composition is between 1 and 10.

2. The composition of claim 1 wherein the predetermined concentration of ozone is between 0.1 and 200 PPM (parts per million).

3. The composition of claim 1 wherein the additive comprises a corrosion inhibitor.

4. The composition of claim 3 wherein the corrosion inhibitor is benzotriazole (BTA).

5. A slurry composition of chemical mechanical polishing, the slurry composition comprising:
a component of alumina; and
an aqueous ozone solution with predetermined concentration.

6. The composition of claim 5 wherein a concentration of ozone in the aqueous ozone solution is between 0.1 and 200 PPM (parts per million).

7. The composition of claim 5 further comprising an additive.

8. The composition of claim 7 wherein the additive comprises a corrosion inhibitor.

9. The composition of claim 8 wherein the corrosion inhibitor is benzotriazole (BTA).
